(19) United States
(12) Patent Application Publication
(10) Pub. No.: US 2014/0227450 A1
(43) Pub. Date: Aug. 14, 2014

(54) Device to Paint or Stain Decks and Railings

(71) Applicant: Thomas Hironimus, Lancaster, PA (US)

(72) Inventor: Thomas Hironimus, Lancaster, PA (US)

(21) Appl. No.: 14/109,707

(22) Filed: Dec. 17, 2013

Related U.S. Application Data
(60) Provisional application No. 61/738,227, filed on Dec. 17, 2012.

(51) Int. Cl. B05C 1/06; B05D 1/28

(52) U.S. Cl. CPC B05C 1/06; B05D 1/28
USPC 427/429; 401/143

(57) ABSTRACT

The invention provides a device for applying solution to vertical members comprising a U-shaped brush head terminating in a tapered hollow receptacle for holding solution such as paint or stain and wherein the hollow receptacle tapers from the bottom of the brush head, diminishing in dimension to the elongated handle, and wherein the handle is essentially cylindrical and receives a plunger for pushing the solution into the brush head and out the egress holes.

### CLAIM OF PRIORITY

This patent application claims priority under 35 USC 119 (e) (1) from U.S. Provisional Patent Application Ser. No. 61/738,227 filed Dec. 17, 2012, of common inventorship herewith entitled, “Device to Stain or Paint Decks and Railings.”

### FIELD OF THE INVENTION

The present invention pertains to the field of stains and paints, and more specifically to the field of stain and paint applicators.

### BACKGROUND OF THE INVENTION

The prior art has put forth several designs for paint applicators. Among these are:

US Patent 2006/0123577 to Dean L. Luster describes an apparatus for applying protective coatings to deck and stair balusters. The applicators include elongated rods connected at one end to form tongs. The other ends carry base plates so configured that they contact baluster surfaces when the user forces these tong ends toward each other. Paint pads are attached to the base plates so that the baluster surfaces are coated readily.

US Patent 2009/0100624 to Anna MacCormick describes a crack and groove stain and paint tool and method of staining or painting a crack or groove with the crack and groove stain and paint tool. The tool comprises a handle, a flat blade attached to the handle having a first face and a second face separated by an edge, and a backing fabric secured to the blade with the backing fabric having a stain or paint holding nap thereon with the backing fabric extending from the first face to the second face of the blade.

U.S. Pat. No. 8,210,760 to Jeffrey E. Sandahl and Timothy Jon Wessels describes coating material applicators for applying a coating material such as stain to a surface such as a deck, characterized by a generally planar surface with intentional gaps between elements or boards of a deck. The coating material applicator is configured to apply a coating material to a structure having a generally planar surface formed by members having opposed surfaces separated by one or more gaps. The coating material applicator includes a base layer having an applicator surface for applying a coating material to the generally planar surface and a removable implement for applying the coating material to the opposed surfaces.

None of these prior art references describe the present invention.

### SUMMARY OF THE INVENTION

It is an object of the present invention to provide a brush apparatus for painting and applying solution such as paint or stain to vertical members, or symmetrical shafts, commonly called spindles and balusters, found on outdoor decks and other architectural applications.

It is a further object of the present invention to provide a device comprising a U-shaped brush head having three brush pads mounted on three sides describing the interior of the U-shaped brush head, and wherein the brush head has egress holes on the sides of the U-shape covered by the brush pads, and wherein the brush head terminates in a tapered hollow receptacle for holding solution such as paint or stain and wherein the hollow receptacle tapers from the bottom of the brush head, diminishing in dimension to the elongated handle, and wherein the handle is essentially cylindrical and receives a plunger for pushing the solution into the brush head and out the egress holes, further comprising a hole with cap near the base of the brush head, wherein the cap is removable.

### BRIEF DESCRIPTION OF THE DRAWINGS

FIG. 1 is a prototypical illustrative diagonal back view showing an unattached cap, wand or handle, and plunger components.

FIG. 2 is a prototypical illustrative side view showing a valve and attached cap that draws fluid into the wand or handle.

FIG. 3 is a prototypical illustrative front view showing small holes behind a brush or pad installed in the U shaped head portion of the present invention.

FIG. 4 is a prototypical illustrative top down view showing three brushes or pads that are installable in the U shaped head portion of the present invention.

FIG. 5 is a cutaway side view showing the inner workings of the device of the present invention.

### DETAILED DESCRIPTION OF THE INVENTION

The do it yourself term applies in its broadest sense to a range of tasks, usually domestic projects of repair or improvement, completed by individuals who are amateurs in the field. Instead of hiring professional contractors, many homeowners enjoy learning new skills, adapting individual styles, and incorporating materials and techniques from local sources to beautify and improve their homes. Along with substantial labor savings, a high degree of personal satisfaction is a motivating incentive for many do it yourselfers. A weekend painting project provides an opportunity to enhance one's self esteem as well as reduce stress. People who do it themselves tend to view themselves as competent, capable and goal oriented. One way homeowners enhance the exterior of their home is by building a wooden deck. A raised structure usually added to the back or front of the home, a deck serves as a large porch big enough to accommodate lounge chairs, barbecue grills and an assortment of outdoor creature comforts. Decks are great for relaxing with good reading material, sunbathing, enjoying an outdoor meal or hosting a party for family and friends. Wooden decks are wonderful additions to any home, but require regular maintenance to keep them in top shape. Homeowners apply a stain or weather resistant paint to untreated deck wood to protect it from damage caused by the elements. Wielding a tiny brush covered with paint or stain material over the many open symmetrical deck adornments such as spindles and balustrades is a time consuming and arduous task. Homeowners who wish to add convenience and luxury to their homes by constructing decks are faced with arduous maintenance duties.

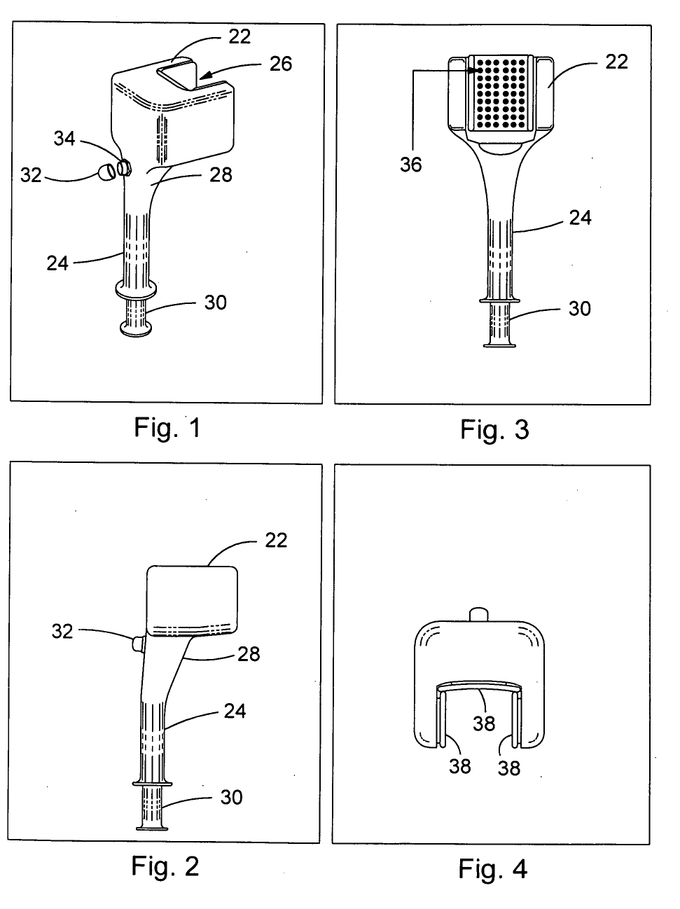

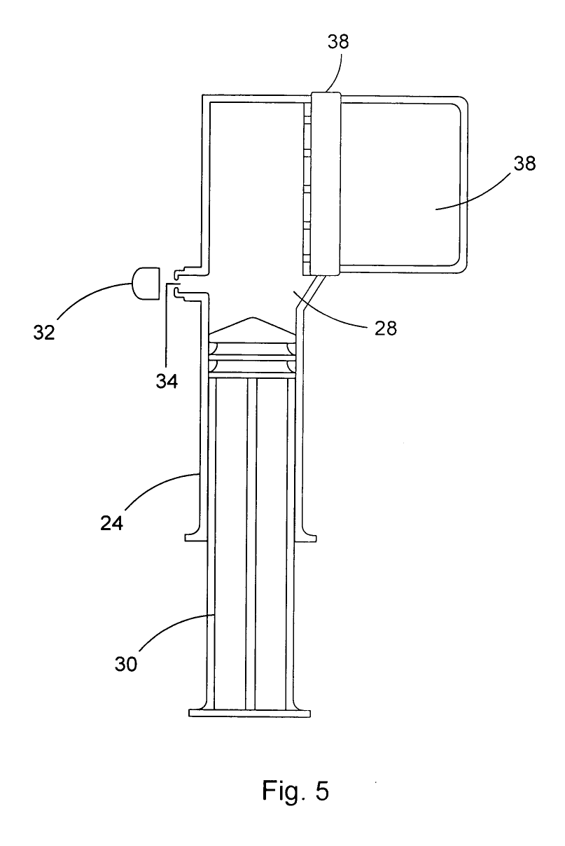

The present invention, hereafter referred to as the Device to Stain or Paint Decks and Railings, is a semicircular or U-shaped brush apparatus for painting and applying stain to symmetrical shafts found on outdoor decks. The present invention provides users with an easier and less time consuming means of coating the spindles and balustrades of deck construction. Stain or paint coatings are swiftly and neatly applied in a fraction of the time normally required. Please refer to FIG. 1. Largely fabricated of a durable plastic material, the Device to Stain or Paint Decks and Railings is comprised of an elongated handle attached to a U shaped brush head 22. The handle 24 measures approximately eleven inches in length. The brush head 22 measures approximately five and one quarter inches in width, three and one half inches in depth, and nine and one quarter inches in circumference. The handle 24 of the present invention comprises a hollow receptacle 26 and a brush head 28 receptacle for solution such as paint or stain. This solution is distributed on brushes with a plunging syringe 30 mechanism that fits into the handle 24. A syringe cap 32 is located on the handle and can be removed to open a hole 34 to allow for the flow of air which pneumatically helps power the device. The distal brush head section or the U shaped portion 22 is augmented with a series of egress holes 36. These holes distribute the stain or paint solution on to three flattened brush pads 38, each of which is fitted to the sides and valley of the brush head 22. Replacement brush pads 38 for the U shaped head 22 are manufactured and available separately.

Use and application for the Device to Stain/Paint Decks and Railings is very simple and straightforward. First, stain paint is transferred into the present invention's handle receptacle 28 by pouring the stain or paint into the hole 34, or utilizing the plunger mechanism to draw the liquid into the brush head. This same action forces liquid on to the brush pads and saturates them with stain or paint. It is also contemplated that solution can simply be poured into the receptacle by removing the plunger 30 and pouring the solution into the opening that receives the plunger 30. To paint a vertical member such as a spindle or balustrade, the U shaped head 22 is fitted around the spindle or balustrade where it surrounds a shaft on three sides. With simple up and down motion, a user is able to completely coat the shaft of the vertical member. As the fluid level lowers, the user removes the cap on the handle to draw in more air. The tool then is held upside down to allow an intake of air to force the remaining liquid out through the egress holes and on the brushes. This process is repeated as often as needed.

The Device to Stain/Paint Decks and Railings provides consumers with a simple and effective means of properly maintaining wooden decks. A staining and painting tool with an easy grip handle and creatively shaped brush head, the present invention seamlessly fits around spindles and balustrades, evenly coating these cylindrical shafts with three brushing pads at once. The paint or stain work is completed three times faster than using one small standard paint brush. Eliminating hours from the task, the Device to Stain/Paint Decks and Railings alleviates blistered hands and reduces back and shoulder strain. The present invention also works efficiently in treating porch railings and interior and exterior stair banisters. Fabricated of durable, high quality materials and components, the present invention withstands repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A device to paint or stain decks or railings comprising:
a semicircular or U-shaped brush head having brush pads and egress holes, a tapered hollow receptacle, an elongated handle, a plunger, an opening and a cap, wherein the U-shaped brush head has three brush pads mounted on three sides describing the interior of the U-shaped brush head, and wherein the brush head has egress holes on the sides of the U-shape covered by the brush pads, and wherein the brush head terminates in a tapered hollow receptacle for holding solution such as paint or stain and wherein the hollow receptacle tapers from the bottom of the brush head, diminishing in dimension to the elongated handle, and wherein the handle is essentially cylindrical and receives a plunger for pushing the solution into the brush head and out the egress holes, further comprising a hole with cap near the base of the brush head, wherein the cap is removable.

2. The device of claim 1, wherein the device is made of durable plastic material.

3. A method of painting or staining a vertical member such as a spindle or balustrade, comprising fitting the U shaped head of the device of claim 1 around the spindle or balustrade where it surrounds a shaft on three sides; move the device up and down to completely coat the shaft of the vertical member.

4. The method of claim 3 further comprising removing the cap on the handle to draw in more air as the solution level lowers.

5. The method of claim 3 further comprising holding the device of claim 1 upside down to allow an intake of air to force the remaining liquid out through the egress holes and onto the brushes.
